(19) United States
(12) Patent Application Publication
(10) Pub. No.: US 2016/0245324 A1
(43) Pub. Date: Aug. 25, 2016

(54) APPLIANCE FASTENING APPARATUS

(71) Applicant: A. RAYMOND ET CIE, Grenoble (FR)

(72) Inventors: Dorian J. KILGORE, Commerce Township, MI (US); Elio EVANGELISTA, Chesterfield, MI (US); William TELLER, Lake Orion, MI (US)

(73) Assignee: A. Raymond & Cie, Grenoble (FR)

(21) Appl. No.: 15/026,638

(22) PCT Filed: Oct. 8, 2014
(86) PCT No.: PCT/US2014/059690

§ 371 Date: Apr. 1, 2016

Related U.S. Application Data
(60) Provisional application No. 61/890,655, filed on Oct. 14, 2013.

(51) Int. Cl. F16B 21/08; F25D 23/06; F16B 37/04

(52) U.S. Cl. CPC F16B 21/086; F16B 37/041; F16B 37/044; F25D 23/067

(57) ABSTRACT

An appliance fastening apparatus is provided. In another aspect, a polymeric fastener includes an anti-rotational formation or surface. Another aspect of the appliance fastening apparatus includes a polymeric section essentially encapsulating a metallic nut therein. In yet another aspect, flexible polymeric barbed legs extend through a hole in an appliance wall such that wedge-shaped or barbed sections thereof are essentially on an opposite surface of the appliance wall from a polymeric head and/or metallic nut coupled thereto.

### CROSS-REFERENCE TO RELATED APPLICATIONS

This application claims the benefit of U.S. Provisional Application No. 61/890,655, filed on Oct. 14, 2013, which is incorporated by reference herein.

### BACKGROUND AND SUMMARY

The present invention relates generally to appliance fastening apparatuses and more particularly to a fastener attached to a hole in an appliance.

It is common to employ many sheet metal anchor nuts to secure screws extending through a hole within an internal liner of a refrigerator appliance. These screws are typically used to attach shelf mounting brackets within the liner. Examples of such anchoring devices are disclosed in U.S. Pat. No. 4,647,263 entitled “Nut Plate Fastener” which issued to Macfee, Jr. et al. on Mar. 3, 1987; U.S. Pat. No. 4,325,178 entitled “Screw Anchoring Device and Method” which issued to Pruehs on Apr. 20, 1982; and U.S. Pat. No. 3,802,476 entitled “Screw Anchor” which issued to Hoadley on Apr. 9, 1974, all of which are incorporated by reference herein.

In commercial practice, the most common type are those like the '178 Pruehs patent, however, a double-sided, pressure sensitive adhesive tape is required between the flat portion of the fastener and an exterior surface of the liner. This extra adhesive tape is intended to both seal the liner hole against insulating foam leakage and to also supplementally secure the fastener to the liner while the foam is injected into the appliance between the liner and an outer metallic shell. Nevertheless, in practice, the foam injection still disengages and displaces one or more of the many fasteners which then necessitates scrapping the entire appliance since it is cost prohibitive to rectify the internal fastener placement after the foam has been injected. In an effort to overcome this problem, an operator is often forced to manually apply a second layer of adhesive tape external to the fastener to supplementally hold it against the liner prior to foam injection. Needless to say, placement of a single adhesive tape layer, let alone two, for each of many screw anchoring fasteners is very labor intensive and expensive, yet is still prone to displacement concerns when the foam is injected. Furthermore, a reduction in foam leakage is desired in order to reduce manual rework and aesthetic concerns inside the liner.

In accordance with the present invention, an appliance fastening apparatus is provided. In another aspect, a polymeric fastener includes an anti-rotational formation or surface. Another aspect of the appliance fastening apparatus includes a polymeric section essentially encapsulating a metallic nut therein. In yet another aspect, flexible polymeric barbed legs extend through a hole in an appliance wall such that wedge-shaped or barbed sections thereof are essentially on an opposite surface of the appliance wall from a polymeric head and/or metallic nut coupled thereto. A further aspect employs a flexible and polymeric umbrella to assist in deterring insulating material from leaking through an appliance hole. A method of using and/or manufacturing a polymeric appliance fastener is also provided.

The present appliance fastening apparatus is advantageous over traditional devices. For example, the present fastener will not be dislocated or removed during foam insertion. Furthermore, the present fastener deters foam leakage through the appliance hole without requiring adhesive tape. Moreover, the present apparatus is advantageously useful for a hole in an appliance interior liner, such as to secure shelf bracketry, and is also usable for a hole in an exterior shell of the appliance such as to secure a leveling or anti-tipping foot. Additional advantages and features of the present invention will become apparent from the following description and associated claims, taken in conjunction with the accompanying drawings.

### BRIEF DESCRIPTION OF THE DRAWINGS

FIG. 1 is a perspective view showing an appliance including multiples of the present appliance fastening apparatus;

FIG. 2 is an interior perspective view, taken within circle 2 of FIG. 1, showing the present appliance fastening apparatus;

FIG. 3 is a cross-sectional view, taken along line 3-3 of FIG. 2, showing the present appliance fastening apparatus;

FIG. 4 is an exterior perspective view, taken generally opposite that of FIG. 2, showing the present appliance fastening apparatus;

FIG. 5 is a perspective view showing a nut employed in the present appliance fastening apparatus;

FIG. 6 is an exterior elevational view, taken generally in the direction of FIG. 4, showing the present nut;

FIG. 7 is a side elevational view showing the present nut;

FIG. 8 is a side elevational view, taken opposite that of FIG. 7, showing the present nut;

FIG. 9 is a cross-sectional view, taken along line 9-9 of FIG. 6, showing the present nut;

FIG. 10 is a perspective view, taken generally in the same direction as FIG. 2, showing a preferred fastener employed in the present appliance fastening apparatus;

FIG. 11 is a perspective view, generally taken in the direction of FIG. 4, showing the present fastener;

FIG. 12 is a cross-sectional view, taken along line 12-12 of FIG. 11, showing the present fastener;

FIG. 13 is a cross-sectional view, taken along line 3-3 of FIG. 2, showing the present appliance fastening apparatus prior to insertion of a threaded screw;

FIG. 14 is a perspective view showing an alternate embodiment fastener employed with the present appliance fastening apparatus;

FIG. 15 is a perspective view, taken generally opposite that of FIG. 14, showing the alternate embodiment fastener; and

FIG. 16 is a cross-sectional view, taken along line 16-16 of FIG. 1, showing the present appliance fastening apparatus used with a leg leveler.

### DETAILED DESCRIPTION

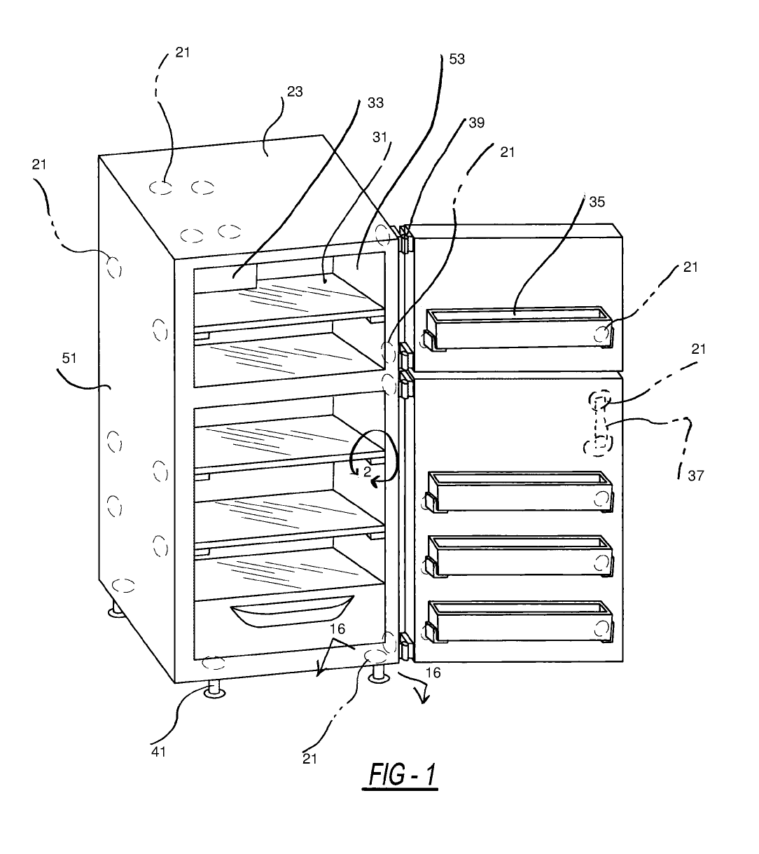

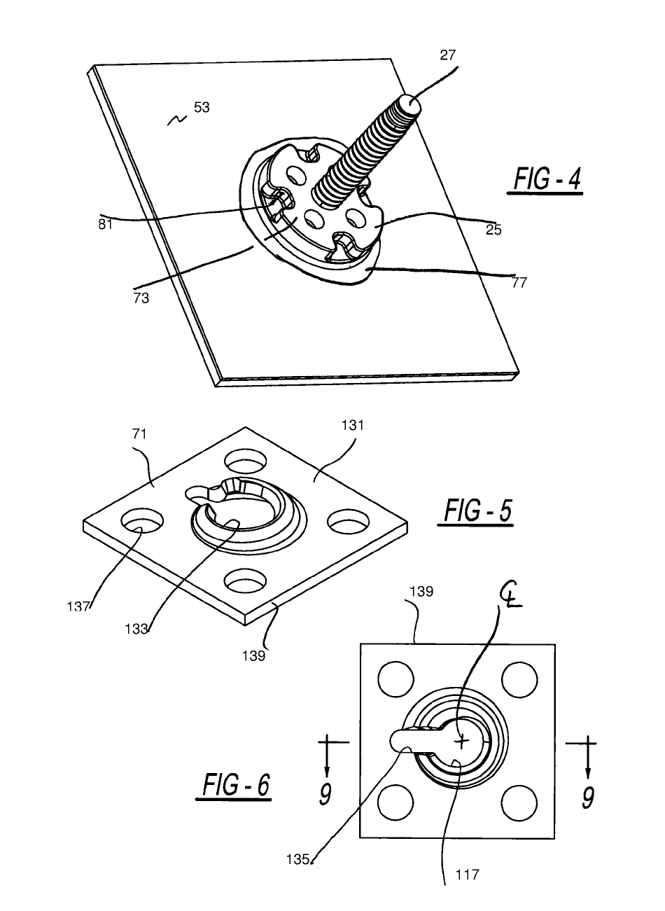

Referring to FIGS. 1-4 and 10-13, the appliance fastening apparatus 21 of the present invention includes an appliance 23, also known as a white good, a fastener 25 and a threaded screw 27, which includes an elongated shaft and can alternately be a bolt. Screw 27 retains a bracket 29 supporting a moveable internal appliance shelf 31, ice maker or water dispenser 33, door shelves 35, exterior handles 37, hinges 39 or foot levelers 41. The preferred appliance 23 is a refrigerator or freezer, as shown, but may alternately include a stove and oven appliance, a dishwasher appliance, a clothes washing machine appliance, a clothes dryer appliance, or the like. Fasteners and foot levelers of such alternate appliances may be replaced by those of the present disclosure, and are shown in the following U.S. Pat. No. 7,959,742 entitled “Outer Support Body for a Drawer-Type Dishwasher” which issued to Cordill et al. on Jun. 14, 2011; U.S. Pat. No. 6,533,238 entitled “Versatile Anti-Tip Bracket for an Appliance” which issued to Barnes et al. on Mar. 18, 2003; and U.S. Pat. No. 4,890,813 entitled “Anti-Tip Bracket for Ranges” which issued to Johnson et al. on Jan. 2, 1990; all of which are incorporated by reference herein.

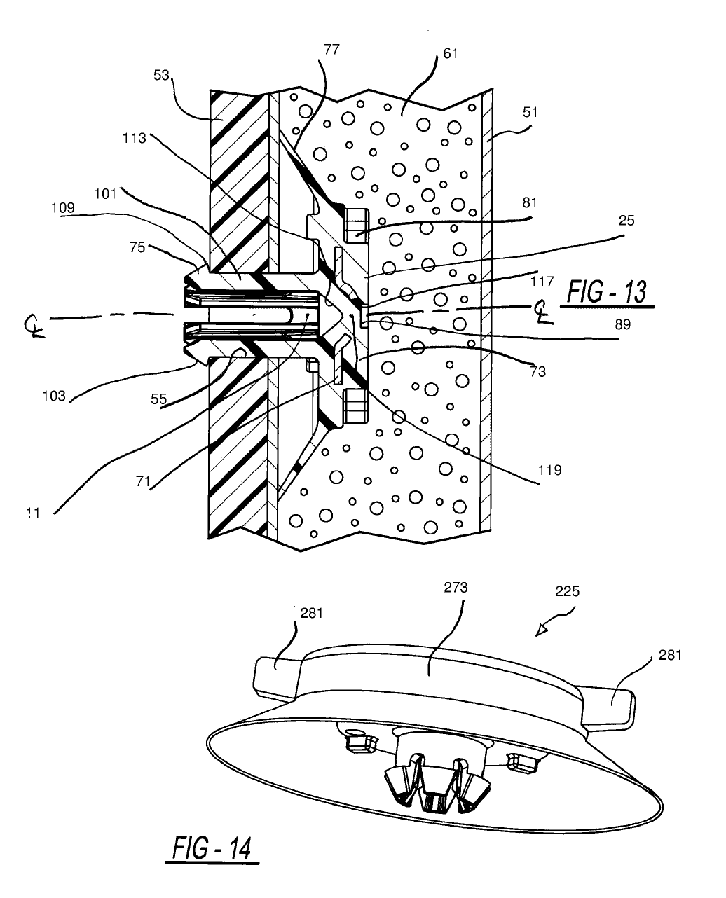

The preferred refrigerator and freezer appliance 23 further include a structural, outer metallic shell or wall 51 and an interior liner or wall 53 which is a structural, thermo-formed or vacuum formed polymeric member. A hole 55 (see FIGS. 3 and 13), is punched through inner or outer walls, 53 and 51 respectively, in multiple locations depending upon where through fasteners are desired. After fastener 25 has been attached to hole 55 in the interior or exterior walls, and the inner liner 53 has been assembled to shell 51, an insulating material, such as a liquid and expandable polyurethane foam 61 is injected or poured between the inner and outer walls and in contact with the exposed portions of fastener 25.

Referring now to FIGS. 10-13, fastener 25 is entirely injection molded from a polymeric material, such as polypropylene or ABS, but for a metallic nut 71. Fastener 25 includes a generally circular-cylindrical head 73, barbed legs 75 and a flexible and frusto-conically shaped umbrella 77, all integrally made as a single piece from the polymeric material. Head 73 includes at least two and more preferably four recessed cavities 81 which radially project away from a centerline of the fastener co-axially aligned with hole 55. The injected foam 61 engages and contacts within recessed cavities 81 and the upstanding surface formations defining such, thereby serving as anti-rotational features after the foam cures. Screw 27 is inserted into the nut as will be later discussed. Passageways 83 are also located in an otherwise generally flat surface 85 of head in a generally parallel direction to the centerline of the part. These passageways 83 provide access for locating pins to support nut 71 during the insert molding process used to create the polymeric portions of fastener 25 encapsulating the nut. A partial passageway 89 is located within head 73 aligned with centerline. Additional passageways 91 are also positioned in the under surface of head 85 to allow molding pin support for nut 71. Additionally, ribs 93 project from the under surface of head 73 to deter over compression of umbrella 77 during insertion of leg 75 into the appliance hole 55, during foam injection, and/or during over-torquing of threaded screw 27.

Each polymeric leg 75 includes a medial stem section 101 and a wedge shaped or barbed end section 103 having internal and external tapers on tips thereof. The external and laterally facing surfaces (i.e., opposite a hollow bore 111) of each leg has an arcuate shape such that when the legs are all compressed together toward the centerline, they generally define circular cross-sections along the length thereof. Each leg 75 is spaced apart from its adjacent neighbors in a partially severed manner by slotted openings 107 having terminal points of which are preferably slighting spaced away from the underside surface of head 73 depending upon the leg flexure and stiffness desired. The triangular point 109 of each barbed section extends completely through hole 55 in the appliance wall such that point 109 is on an opposite surface of the wall from umbrella 77 and head 73.

A generally cylindrical, hollow bore 111 projects within legs 75 coaxial with the centerline. This bore 111 preferably terminates in a generally conical end 113 internal to head 73 and aligned with a centerline of an aperture 117 of nut 71. The very thin distance between the end of bore 111 and the bottom of partial passageway 89 is little more than molding flash which defines a bridging segment 119 spanning across aperture 117 of nut 71. Bridging segment 119 assists in sealing the fastener to deter foam from leaking through the appliance hole 55. Bridging segment 119 is frangible or breakable upon piercing insertion of threaded screw 27. It is preferred that threaded screw 27 have a flat or rounded distal end such that it need not be a self-piercing screw, however, a self-piercing screw can alternately be employed. At least one flexible barbed leg is employed, more preferably at least three such legs are used, and it is most preferable to use six equilaterally spaced apart legs, especially if a circular hole is employed in the appliance wall.

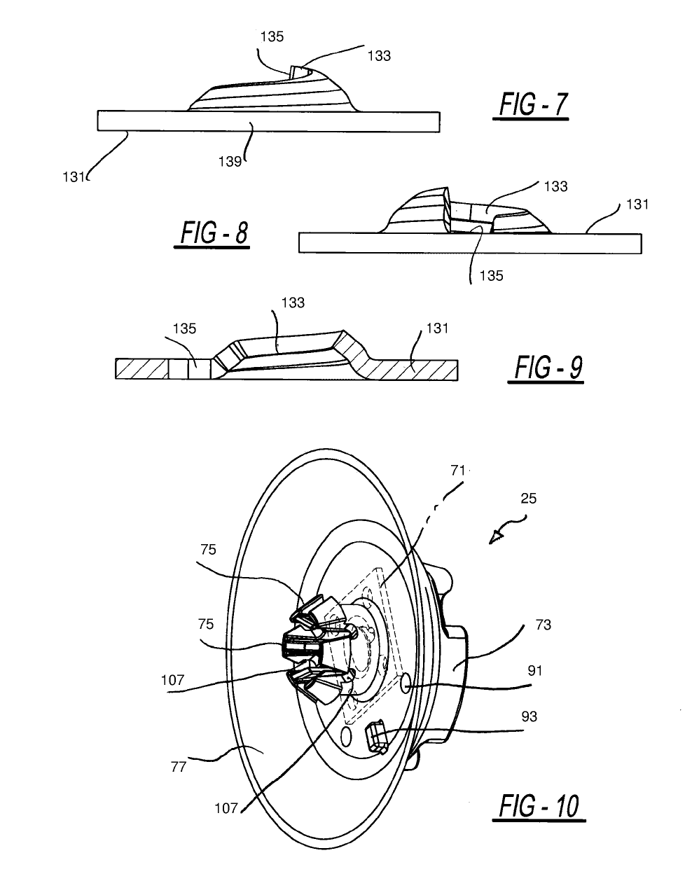

Nut 71 is best illustrated in FIGS. 5-9. Nut 71 is preferably stamped from carbon mild, spring or stainless steel having a Rockwell hardness of approximately 30 newtons. It is designed as a lock nut having a generally flat and uniformly dimensioned body 131 and a central raised dome area defining a single thread internal edge 133 creating a generally spirally circular part of its aperture 117. A single slot 135 is also cut from one side of aperture 117 to allow for flexed expansion of thread 133 during threaded screw engagement. Openings 137 are also provided in body 131 to allow for polymeric flow through during the insert molding to maintain a better engagement between the polymeric head and metallic nut of the fastener. Additionally, a periphery 139 of nut is generally polygonal, and more preferably square, with essentially flat edge surfaces to further minimize rotation of the nut relative to the polymeric head during screw insertion.

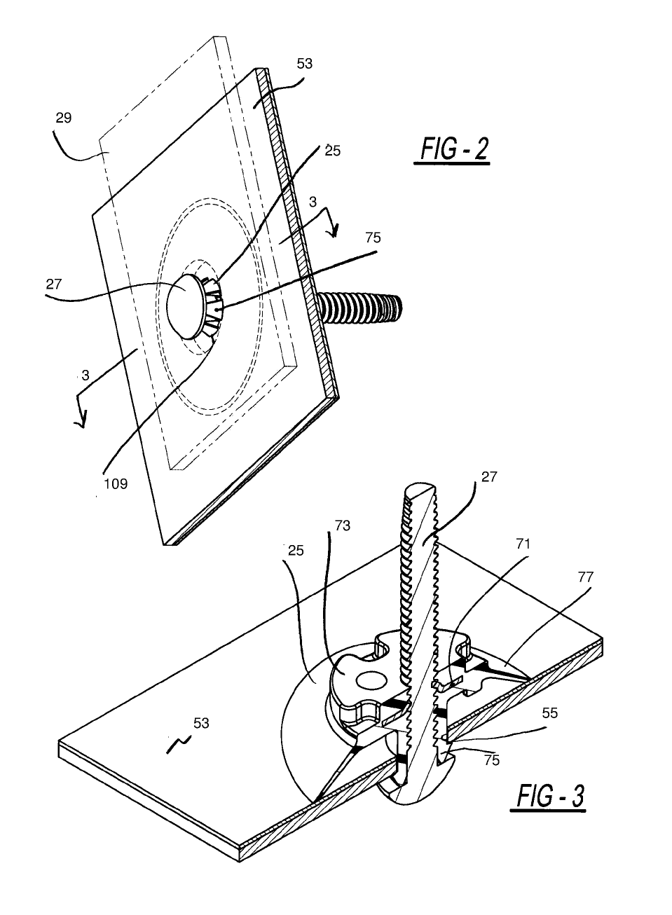

FIGS. 2 through 4 and 13 show fastener 25 manually attached to wall 53 of appliance. In this condition, legs 75 of fastener 25 are snap-fit inserted through hole 55. Foam 61 is injected thereagainst whereby flexed umbrella 77 and bridging segment 119 act to seal foam 61 from leaking through hole 55. Thereafter, threaded screw 27 is manually screwed into engagement within hollow channel 111 and then with the internally threaded aperture 117 of nut 71 as it pierces through the bridging segment of polymeric material spanning thereacross. The distal end of threaded screw 27 continues to extend through partial passageway 89 and then into foam 61.

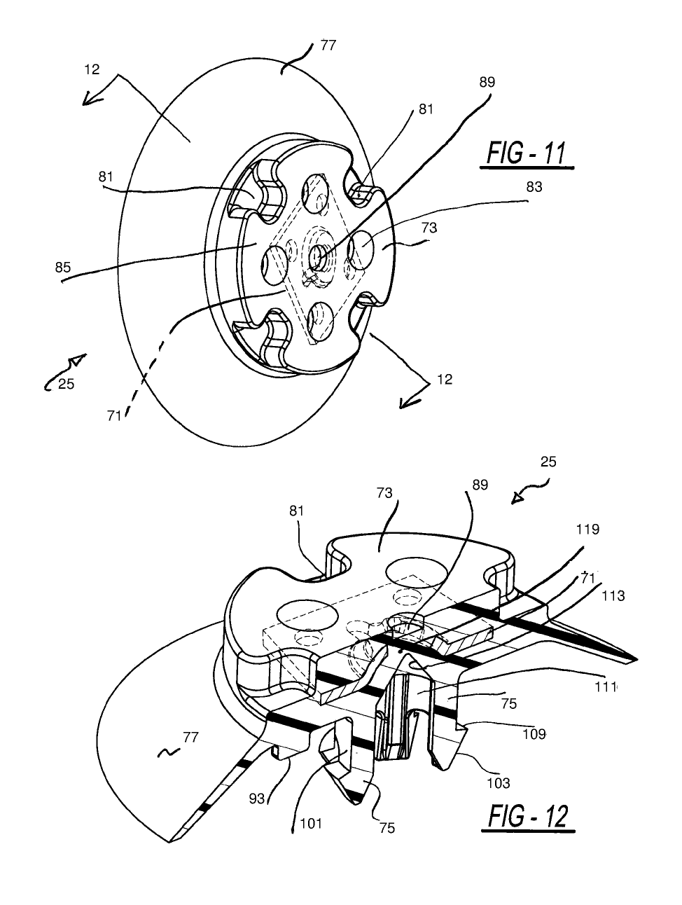

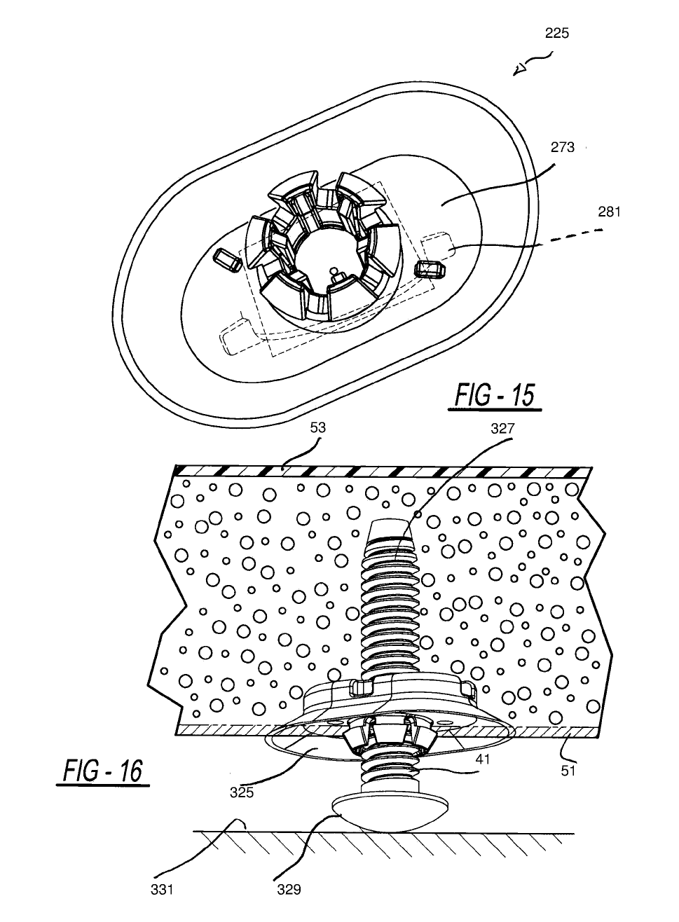

An alternate configuration of fastener 225 is illustrated in FIGS. 14 and 15. This construction is identical with the prior fastener, however, a head 275 has radially and laterally projecting wall formations 281 thereon instead of recessed cavities as in the prior embodiment. The only other noteworthy difference in the fastener embodiments is that the present fastener 225 also has a generally oval shaped head and umbrella periphery instead of the prior circular shape. It may alternately be defined as a substantially elliptical-cylindrical periphery. It should be appreciated that the anti-rotational features 81 (see FIG. 11) or 281 (see FIG. 14) can be interchanged between each other and/or added to the other.

FIG. 16 illustrates the same fastener 325 of either of the prior embodiments. In this configuration, however, a threaded shaft 327 constitutes a leg leveler wherein a foot 329 contacts a floor 331 such that location of leg leveler 327 relative to fastener 325 adjusts the height of the appliance relative to the floor.

While various embodiments of the present invention have been disclosed, it should be appreciated that other variations may be employed. For example, while a stamped sheet metal nut is disclosed, it should alternately be clear that a cast, machined, sintered, or even injection molded polymeric nut may be used, although the present cost and strength benefits may not be obtained. Furthermore, additional polymeric sections may be constructed between the legs, umbrella, head and anti-rotational surfaces, and/or appended thereto, although some of the present cost and packaging benefits may not be realized. Additionally, the presently disclosed arcuate leg, umbrella, and head peripheries may be substituted with one or more straight surfaces, especially if the appliance hole shape is rectangular, however, certain advantages may not be realized. It is intended by the following claims to cover these and any other departures from the disclosed embodiments which fall within the true spirit of this invention.

The invention claimed is:

1. An appliance apparatus comprising:
(a) an appliance comprising a structural wall, having a hole, and foam located against the wall; and
(b) a fastener comprising at least one polymeric barbed leg and a polymeric head, the at least one barbed leg operably engaging through the hole in the wall, the head including at least one anti-rotational surface which is held substantially stationary when contacted by the foam, and a metallic thread-engaging surface located adjacent the head and aligned with the hole of the wall.

2. The appliance apparatus of claim 1, wherein the thread-engaging surface is part of a metallic nut attached to the head, the nut including at least one flat peripheral surface.

3. The appliance apparatus of claim 2, wherein the metallic nut is substantially encapsulated within the polymeric head, and the at least one polymeric barbed leg includes a point outwardly facing away from a centerline of the hole of the wall, and the point is inserted completely through the hole.

4. The appliance apparatus of claim 2, wherein the metallic nut is stamped sheet steel including a central aperture defining an internal thread, and the metallic nut further includes a substantially polygonal body to prevent rotation of the nut relative to the polymeric fastener head.

5. The appliance apparatus of claim 1, further comprising an externally threaded shaft inserted into the hole of the wall between at least a pair of the barbed legs, the shaft enmeshing with the thread-engaging surface of the fastener, and the wall is a polymeric interior liner of the appliance.

6. The appliance apparatus of claim 1, further comprising:
a shaft having a head and an opposite end;
the polymeric head entirely encapsulating all of the thread-engaging surface, which is metallic, including a bore therein, at least prior to insertion of the shaft; and
an end of the shaft piercing through a thin section of polymeric material of the fastener aligned with the hole, when the shaft is inserted through the entire fastener.

7. The appliance apparatus of claim 1, further comprising a flexible polymeric umbrella extending from the fastener, the umbrella contacting against a surface of the wall and deterring leakage of the foam through the hole in the wall.

8. The appliance apparatus of claim 1, wherein the anti-rotational surface of the fastener includes a recessed cavity.

9. The appliance apparatus of claim 1, wherein the anti-rotational surface of the fastener includes a laterally projecting wall radially extending relative to the head.

10. The appliance apparatus of claim 1, wherein the fastener is secured to the appliance by at least three of the polymeric barbed legs and free of an adhesive, at least prior to contact by the foam, and the legs all have a curved outer surface which engages against the hole which is circular.

11. The appliance apparatus of claim 1, further comprising a shelf bracket secured to the fastener by an externally threaded shaft engaging the thread-engaging surface of the fastener, and the appliance is at least one of : (a) a refrigerator, or (b) a freezer.

12. The appliance apparatus of claim 1, further comprising a rotatable leg leveler moveably attached to the fastener, and the wall is an exterior metallic shell.

13. An appliance apparatus comprising:
(a) an appliance including a hole; and
(b) a fastener comprising at least three flexible barbed legs and a polymeric section, a metallic nut at least partially encapsulated within the polymeric section of the fastener, and a bore of the nut being aligned with the hole of the appliance when the barbed legs engage the hole.

14. The appliance apparatus of claim 13, wherein a substantially polygonal periphery of the metallic nut is substantially encapsulated within the polymeric section of the fastener which includes a peripherally curved head.

15. The appliance apparatus of claim 13, wherein the metallic nut is stamped sheet steel including a central aperture defining an internal thread, and the metallic nut further includes a substantially polygonal body to prevent rotation of the nut relative to the polymeric section of the fastener.

16. The appliance apparatus of claim 13, further comprising an externally threaded shaft inserted into the hole of the appliance between the barbed legs, the shaft enmeshing with the metallic nut, and the insulator engaging against and deterring rotation of the fastener without the use of an adhesive tape.

17. The appliance apparatus of claim 13, further comprising:
a shaft having a head and an opposite end;
the polymeric section entirely encapsulating all of the nut, which is metallic, including a bore therein, at least prior to insertion of the shaft; and
an end of the shaft piercing through a thin section of polymeric material of the fastener aligned with the hole, when the shaft is inserted through the entire fastener.

18. The appliance apparatus of claim 13, further comprising a flexible polymeric umbrella extending from the polymeric section of the fastener, the umbrella contacting against a wall surface of the appliance and deterring foam from leaking through the hole.

19. The appliance apparatus of claim 13, further comprising a rotatable leg leveler moveably attached to the fastener and the hole being through an exterior shell of the appliance.

20. An appliance apparatus comprising:
(a) an appliance comprising a structural wall having a hole, and foam located against the wall; and
(b) a fastener comprising:
a polymeric head;
a flexible polymeric umbrella coupled to the head; and
polymeric legs coupled to the head and having wedge-shaped sections, the legs being configured to extend through the hole in the wall such that the wedge-shaped sections are configured to engage an opposite surface of the wall.

21. The appliance apparatus of claim 20, further comprising an internally threaded nut coupled to the head of the fastener.

22. The appliance apparatus of claim 21, wherein the head includes a first portion that covers a first end of the nut, a second portion that covers a second end of the nut, and a third portion that covers a perimeter of the nut.

23. The appliance apparatus of claim 21, wherein the head includes a fourth portion that bridges across a threaded bore in the nut.

24. The appliance apparatus of claim 21, wherein the metallic nut is stamped sheet steel including a central aperture defining an internal thread, and the metallic nut further includes a substantially polygonal body to prevent rotation of the nut relative to the polymeric fastener head.

25. The appliance apparatus of claim 20, wherein the head has a substantially circular periphery, and the legs include at least three flexible legs projecting away from the head, and the legs each have a curved outside surface adjacent a lateral point of the wedge.

26. The appliance apparatus of claim 20, wherein the head has substantially elliptical cylindrical periphery.

27. The appliance apparatus of claim 20, further comprising a polymeric anti-rotational formation coupled to the head of the fastener being engaged by the foam.

28. An appliance apparatus comprising:
an appliance-fastener comprising at least one polymeric barbed leg and a laterally enlarged polymeric section;
a nut at least partially encapsulated within the enlarged polymeric section of the fastener, the nut including stamped sheet metal including a central aperture defining an internal thread, the nut further including a substantially polygonal body to prevent rotation of the nut relative to the enlarged polymeric section of the fastener; and
a flexible and polymeric umbrella extending from the enlarged polymeric section of the fastener, the umbrella being co-axially aligned with the central aperture of the nut.

29. The appliance apparatus of claim 28, further comprising an anti-rotational recessed cavity being part of the fastener.

30. The appliance apparatus of claim 28, further comprising an anti-rotational laterally projecting wall being part of the fastener.

31. The appliance apparatus of claim 28, further comprising a leg leveler rotatably engaging the nut of the fastener.

32. The appliance apparatus of claim 28, further comprising a shelf-bracket secured to the fastener by a threaded shaft engaging the nut.

33. The appliance apparatus of claim 28, wherein the at least one polymeric barbed leg includes at least three externally curved polymeric barbed legs co-axially aligned around the central aperture of the nut and pointing away from the nut, and the umbrella laterally enlarges in the substantially same direction as the legs point.

34. A method of securing a fastener to an appliance, the method comprising:
(a) aligning a nut, attached to the fastener, with a hole in the appliance;
(b) inserting barbed legs of the fastener into the hole in the appliance;
(c) compressing a flexible umbrella of the fastener against a surface of the appliance, the umbrella substantially co-axially surrounding one side of the hole;
(d) inserting an insulative material adjacent the surface of the appliance and against the umbrella of the fastener; and
(e) deterring leakage of the insulative material through the hole at least in part of by the umbrella.

35. The method of claim 34, further comprising injection molding a head of the fastener around at least a portion of the nut.

36. The method of claim 34, further comprising stamping the nut from sheet metal prior to it being encapsulated by a polymeric material of the fastener.

37. The method of claim 34, further comprising inserting foam, which is the insulative material, against anti-rotational polymeric formations of the fastener without the use of adhesive tape to secure or seal the fastener to the appliance.

38. The method of claim 34, further comprising rotating an external foot leveler which enmeshes the nut of the fastener.
